(19) United States
(12) Patent Application Publication
(10) Pub. No.: US 2003/0016633 A1
(43) Pub. Date: Jan. 23, 2003

(54) Bandwidth allocation and management system for satellite networks and method therefor

(76) Inventors: Daniel Albert Enns, Phoenix, AZ (US); Naresh Kumer Jain, Tempe, AZ (US); Robert L. McCollum, Chandler, AZ (US)

Correspondence Address: WEISS & MOY PC, 4204 NORTH BROWN AVENUE, SCOTTSDALE, AZ, 85251, US

(21) Appl. No.: 09/910,997

(22) Filed: Jul. 23, 2001

(51) Int. Cl. H04B 7/185; H04J 3/16

(52) U.S. Cl. 370/316; 370/468

(57) ABSTRACT

A network system has a hub site and a plurality of remote sites. A satellite is used for transmitting data to and from the hub site and the remote site. The available bandwidth of the network is divided into separate channels for transmitting and receiving data. In the network call control and management between the hub site and the remote site use internet protocol (IP) addressing for identification.

### BACKGROUND OF THE INVENTION

1. Field of the Invention

This invention relates to the field of networking systems and methods therefor and, more specifically, to an efficient and low cost bandwidth allocation and management system which alleviates the need for separate control equipment at both the hub location and the remote sites.

2. Description of the Prior Art

Present-day network systems communicate through a variety of protocols and channels in order to interconnect computers, telephony devices and other systems that require data, video or voice communications. Quality of Service (QoS) is a designator that is used in network systems to assign or request desirable data transfer characteristics, such as delay and bandwidth characteristics for a given channel. Service quality can be assigned on a per-user basis to provide several levels of interconnect performance conforming to desired performance levels. Users may be charged fees for different performance levels. For example, a business connection or Internet Service Provider (ISP) serving multiple users will have a higher desired performance level than an individual residential customer, and the fees for such performance can be assigned accordingly.

QoS levels are typically set within a network by a configuration manager, which can be coupled to the network or coupled to a network component such as a router. The configuration manager is a program running on a computer that permits setting of network addresses such as Internet Protocol (IP) addresses, QoS requirements for a given connection between addresses and protocols to be used for communication between networked devices.

Many users with small to medium sized satellite networks are precluded from using bandwidth-on-demand solutions due to the high cost of the hub and remote control equipment required to manage the network. Furthermore, all such solutions require separate satellite channels with burst capability for network management traffic between the remote sites and the hub.

Therefore, a need existed to provide an efficient and low cost bandwidth allocation and management system for small and medium sized networks. The efficient and low cost bandwidth allocation and management system must not suffer from the above mentioned problems. The efficient and low cost bandwidth allocation and management system must alleviate the need for separate control equipment at both the hub location and the remote sites. The efficient and low cost bandwidth allocation and management system must not require burst capability or separate control channels. However, the system must be able to be easily adapted to modems that do support burst capability.

### SUMMARY OF THE INVENTION

In accordance with one embodiment of the present invention, it is an object of the present invention to provide an efficient and low cost bandwidth allocation and management system for small and medium sized networks that can also be extended to larger networks.

It is another object of the present invention to provide an efficient and low cost bandwidth allocation and management system that does must not suffer from problems associated with prior art systems.

It is still another object of the present invention to provide an efficient and low cost bandwidth allocation and management system that alleviates the need for separate control equipment at both the hub location and the remote sites.

It is still another object of the present invention to provide an efficient and low cost bandwidth allocation and management system that does not require burst capability or separate control channels. However, the system must be able to be easily adapted to modems that do support burst capability.

### BRIEF DESCRIPTION OF THE PREFERRED EMBODIMENTS

In accordance with one embodiment of the present invention a network system is disclosed. The network system has a hub site and at least one remote site. A satellite is used for transmitting data to and from the hub site and the remote site. The network transmits call control and management messages between the hub site and the remote site using internet protocol (IP) addressing for identification.

In accordance with another embodiment of the present invention a network system is disclosed. The network system has a hub site and a plurality of remote sites. A satellite is used for transmitting data to and from the hub site and the remote site. The available bandwidth of the network is divided into separate channels for transmitting and receiving data. In the network call control and management messages between the hub site and the remote site use internet protocol (IP) addressing for identification.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a block diagram depicting a satellite network communication system within which the present invention may be embodied.

FIG. 2 is a pictorial diagram depicting a database of all modems located in the hub site in accordance with a preferred embodiment of the invention.

FIG. 3 is a pictorial diagram depicting a database of all remote sites in the network in accordance with a preferred embodiment of the invention.

FIG. 4 is a pictorial diagram depicting a database of all available channels in the network in accordance with a preferred embodiment of the invention.

FIG. 5 is a pictorial diagram depicting a database of all in-service channels in the network in accordance with a preferred embodiment of the invention.

FIG. 6 is a pictorial diagram depicting a database of all channel updates in the network in accordance with a preferred embodiment of the invention.

### DETAILED DESCRIPTION OF THE PREFERRED EMBODIMENT

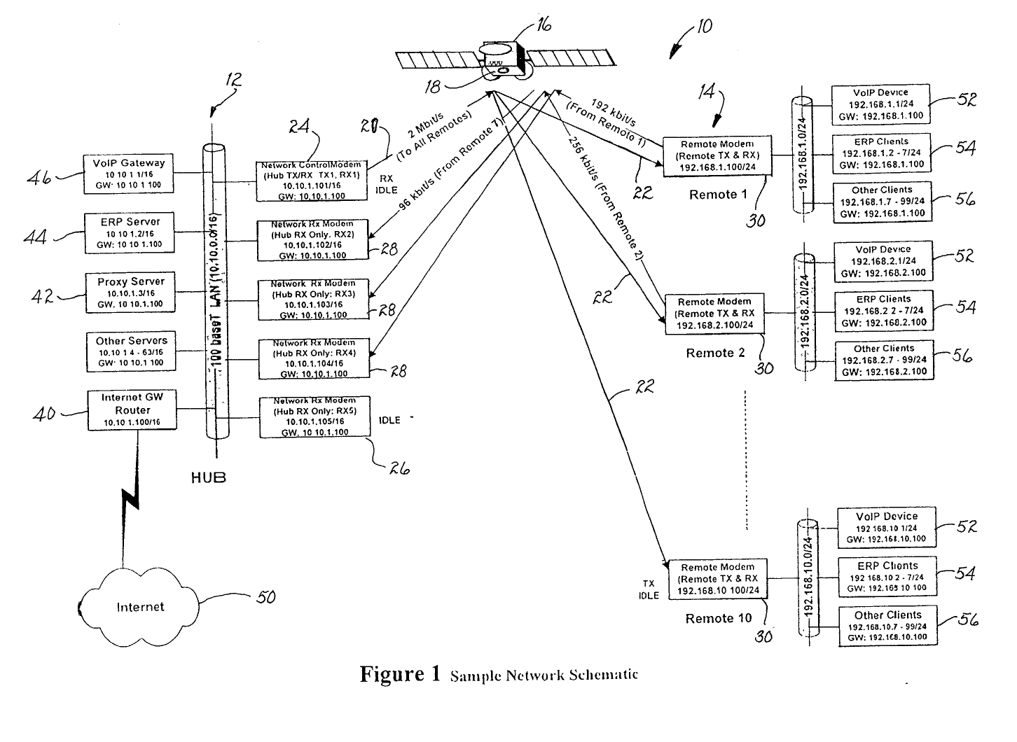

Referring to the FIG. 1, a satellite network communication network 10 (hereinafter network 10) is shown within which the present invention may be embodied. The network 10 has a STAR topology. The network 10 has a hub site 12 and multiple remote sites 14. A satellite 16 contains a transmitter-receiver, transponder or other suitable circuitry for receiving and transmitting information using an antenna 18. The available bandwidth of the network 10 is divided into separate channels. A first channel 20 is used by the hub site 12 to transmit all traffic and control messages to the satellite and down to all the remote sites 14. All other channels 22 may be allocated to remote sites 14 on demand to transfer requests and traffic to the satellite 16 and down to the hub site 12.

The hub site 12 has a primary network control modem 24. The primary network control modem 24 is used to maintain the network 10 database. The primary network control modem 24 is used to transmit data via the shared outbound channel 20. The primary network control modem 24 may further be used to receive data from one of the remote sites 14 via one of the other channels 22.

The network 10 my be configured as a redundant system. In a redundant system, the hub site 12 will have one or more secondary network control modems 26. The secondary network control modems 26 are configured to take over the functions of the primary network control modem 24 when the primary network control modem 24 fails.

The hub site 12 further has one or more network receive modems 28. The network receive modem 28 is used to receive data from one of the remote sites 14 via a channel 22 that is allocated to the remote site 14. Each network receive modem 26 is tuned to a predefined receive carrier channel 22 (i.e., frequency, modulation, data rate, etc.).

The hub site 12 may use a router 40 and a proxy server 42 to connect to and transfer data between the hub site 12 and the Internet 50. The proxy server 42 may further be used as a firewall mechanism. The proxy server 42 may act as a barrier to prevent hackers from accessing the network 10. The proxy server 42 can be used to hide IP addresses of hardware within the network 10 from the Internet 50 since the hardware may not have official registered network numbers.

The hub site 12 may further have other application servers such as an ERP server 44 and a Voice over IP (VoIP) gateway 46. The ERP server 44 is used to support customer's business applications. The VoIP gateway 46 is used to connect the network 10 using Voice-over-IP (VoIP) to the standard public switch telephone network.

Each remote site 14 has a remote modem 30. The remote modem 30 continuously receives data from the outbound channel 20 from the hub site 12. The remote modem 30 further acquires and transmits data via an SCPC return channel 22 when needed. Each remote site 14 may further have one or more different clients/devices coupled thereto. In the embodiment depicted in FIG. 1, each remote site 14 has a VoIP device 52, ERP clients 54, as well as other clients 56.

The network 10 uses a communication protocol for call control and management between the hub site 12 and the remote sites 14. The communication protocol is (User Datagram Protocol/Internet Protocol) UDP/IP based using IP addresses for identification. HDLC encapsulation is used at the link layer.

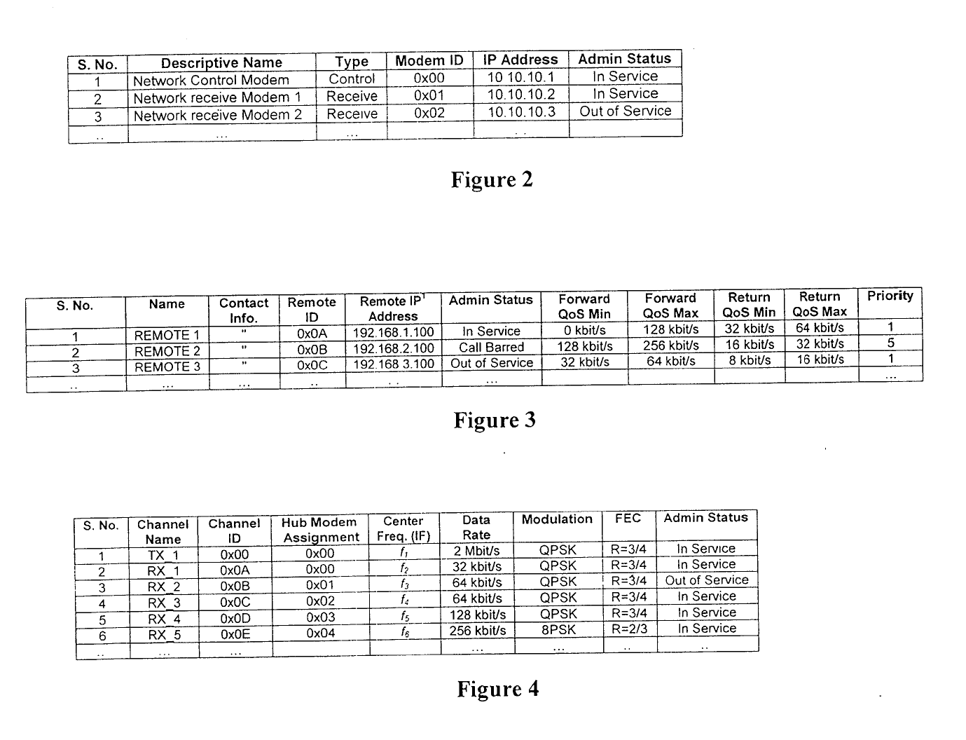

The primary network control modem 24 maintains multiple tables/list relating to the operation of the network 10 which are user configurable. The tables/lists are used for storing the configuration information as well as for distributing the network information to the remote sites 14. The primary network control modem 24 maintains a network modem list as shown in FIG. 2. The network modem list contains a complete database on all the modems at the hub site 12. The network modem list will list the number of moderns at the hub site 12, the type of modem (i.e., control, receive, etc.), the modem ID, the IP address of each modem, and the current status (in service, out of service, etc.). The network modem list may further contain information related to the operational status of each modem (i.e., active, alarm, etc.). The primary network control modem 24 uses this information, as well as information from a master channel list (described below) to configure itself and the network receive modems 28.

The primary network control modem 24 further maintains a complete remote site database as shown in FIG. 3. The remote site database contains information related to each remote sites 14 in the network 10. The remote site database will list the number of remote sites 14, remote site IDs, remote site IP addresses, the status of each remote site (i.e., in service, out of service, call barred, etc.), the minimum and maximum QoS forwarding rate of each remote site 14, the minimum and maximum QoS return rate of each remote site 14, and the priority of each remote site 14. The remote site database may further contain status information such as -active and connected, active and not connected, disconnected, etc.; the incoming hub modem ID; and the average forward transfer rate. The above information is used to select an appropriate return channel 22.

As stated above, the available bandwidth of the network 10 is divided into a desired number of SCPC channels. The network 10 will have one outbound channel 20 and one or more return channels 22. Each network receive modems 28 at the hub site 12 is configured to receive one of the return channels 22. It should be noted that the number of return channels 22 is generally equal to or less than the number of network receive modems 28 at the hub site 12. The primary network control modem 24 maintains a complete master channel database as shown in FIG. 4. The master channel database contains information on all available SCPC channels. The master channel database will contain information relating to the number of SCPC channels, channel names (i.e., transmit, receive, etc.), channel Ids, hub modem assignment of each channel, center frequency of each channel, data rate of each channel, modulation of each channel, and the operating status of each channel (i.e., in service, out of service, etc.). The master channel database may further contain status information such as whether the channel is assigned, free, or locked.

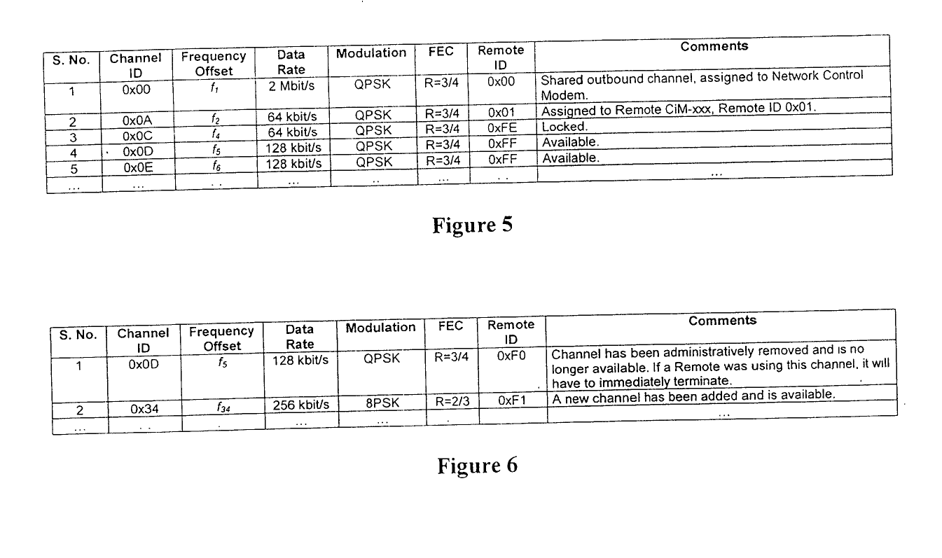

The primary network control modem 24 will further maintain an in-service satellite channel list as shown in FIG. 5. This list will have information relating to all in-service satellite channels along with pertinent configuration and status information. The list is transmitted on a periodic basis, the period being user configurable and can be changed dynamically. The list is also user configurable and is able to be changed dynamically. The in-service satellite channel list will list each channel in-service and its channel ID, the frequency offset of each in-service channel, the data rate of each in-service channel, the modulation of each in-service channel, and the remote ID. For larger networks 10, it may not be very efficient to transmit the in-service channel list on a frequent periodic basis. Thus, for larger networks 10, a subset of the in-service channel list, the channel allocation list, may be transmitted on a frequent periodic basis.

The primary network control modem 24 will further maintain a channel update list as shown in FIG. 6. The channel update list contains information on all the affected channels whenever there is a change in channel configuration. Whenever there is a change in a channel configuration, the channel update list is updated and then transmitted. The channel update list contains each channel affected and its channel ID, the frequency offset of each affected channel, the data rate of each affected channel, the modulation of each affected channel, and the remote ID.

Some of the other tables/list maintained in the network 10 include a channel allocation update list, permitted remote list, and a permitted remote update list. The channel allocation update list is transmitted whenever there is a change in channel allocation. It contains information related to all the affected channels. The permitted remote list indicates if a remote site 14 is allowed to initiate a circuit request and also its configured QoS. The permitted remote list is transmitted on a periodic basis, the period being user configurable. The permitted remote update list is a list that is transmitted whenever there is a change in the permitted remote list. The permitted remote update list only contains the affected entries.

### OPERATION

In prior art networks, the available bandwidth of the network 10 is divided into separate channels. A first channel is used by the hub site 12 to transmit all traffic and control messages to the satellite and down to all the remote sites 14. All other channels 22 may be allocated to remote sites on demand. When the hub site transmits data over the first channel, all of the remote sites receive the data. Each remote site then must decode and extract the appropriate data for that particular remote site.

In contrast, the network 10 uses a communication protocol for call control and management between the hub site 12 and the remote sites 14. The communication protocol is UDP/IP based using IP addresses for identification. HDLC encapsulation is used at the link layer. Each channel in the network 10 is configured to transmit data only to a defined remote site 14 and even to a defined component (i.e., computer terminal) at the remote site 14.

Upon power up, a remote site 14 is configured as per the outbound channel parameters. Once the outbound channel is acquired, the remote site 14 waits for the channel list and the permitted remote list. Once the remote site 14 receives these lists, the remote site 14 has all the information to request a channel provided that it is not administratively barred from doing so.

If a remote site 14 is administratively in service and is not faulted, the remote site 14 may initiate a channel allocation request if the remote site 14 needs a return channel 22 to the hub site 12. Based on the configured QoS of the remote site 14, the remote site determines the type of return channel 22 that is needed. The remote site then searches the channel list to find an appropriate return channel 22 that is available. If there are no available channels 22, the remote site 14 waits for the next update or periodic channel allocation list broadcast. If there is an available channel, it configures its modulator based on the channel configuration. The remote site 14 also selects a transmit power level. The remote site 14 then turns on the modulator and starts an acquisition timer. The remote site 14 formats a channel allocation request message indicating the remote site's ID and the requested channel. The remote site 14 then begins to transmits the message and starts the message transmission timer. The remote site 14 continues to check the channel allocation updates and the periodic channel allocation list broadcast to determine the status of the request. If the message retransmission time expires, the remote site 14 retransmits the message and increments the count. The user data is buffered during this process. If the remote site 14 receives an allocation update or the periodic channel allocation list broadcast indicating that it has been allocated the channel, the remote site 14 stops the acquisition timer, resets the transmit power to nominal and starts transmitting the user data.

Many problems could develop during the above process. Things like the acquisition timer expires; allocation update or the periodic channel allocation list broadcast indicates that the channel has been allocated to some one else; the channel has been administratively removed from service; the outbound channel is lost; the remote site 14 is barred from initiating the request, etc. In all of the above cases, the remote site 14 immediately stops transmission. If the acquisition timer expires or the allocation update or the periodic channel allocation list broadcast indicates that the channel has been allocated to some one else the remote site 14 calculates a random backoff time using the minimum and the maximum backoff received from the primary network control modem 24. Once the backoff time is calculated, the remote site 14 starts the backoff timer. The remote site 14 will repeat the acquisition process upon expiration of the backoff timer. If the channel has been administratively removed from service, the remote site 14 selects another channel from the list and repeats the acquisition process. If the outbound channel is lost, the remote site 14 waits for the outbound channel acquisition and repeats network acquisition before attempting another channel allocation request. If the remote site 14 is barred from initiating the request, then the remote site 14 waits for permission to change.

All of the modems 24 and 28 at the hub site 14 are continuously being polled for carrier detect. As soon as the modems report a carrier detect, the channel lists are updated to indicate “locked” status for the channel and a list update is sent. Once the application receives the allocation request message from the remote site 14, the channel lists are updated accordingly and a list update is sent. The primary network control modem 24 also opens a call record indicating the start time, channel configuration and the remote site ID.

The remote site 14 may wish to terminate the channel on it's own or due to administrative action. For a normal termination sequence, the remote site 14 will send two termination request messages to the primary network control modem 24. The two separate request messages will be spaced a predetermined time frame apart. The remote site 14 will turn off the transmitter and start a termination confirmation timer. The remote site will then wait for an allocation update or periodic channel allocation list broadcast indicating that the channel is no longer allocated to the remote site 14. If deallocation is confirmed, the remote site 14 stops the timer and enters an idle state. If for some reason the termination confirmation timer expires, it turns on the transmitter and repeats the above steps. If the termination is caused due to administrative actions or initiated by the primary network control modem 24 (i.e., due to expiration of the keep alive timer or prolonged loss of the carrier), the remote modem 30, upon receiving the termination message from the primary network control modem 24, will immediately turn off the modulator.

If a receive modem 28 at the hub site 12 loses a carrier detect, the receive modem 28 starts a timer. If the timer expires before a carrier detect is indicated, the receive modem 28 sends a message to the primary network control modem 24. At this time the primary network control modem 24 deallocates the channel and transmits an update indicating the new channel status. The primary network control modem 24 also closes the previously opened call record indicating the end time.

A remote site 14 may at some time wish to request a different channel. This may be due to excessive packet loss (i.e., not enough bandwidth); bandwidth under utilization; or a high Bit Error Rate (BER). In order to request a different channel, the remote site selects an appropriate channel. The remote site formats a channel reallocation request and sends it to the primary network control modem 24 using the currently allocated channel and starts a reallocation timer. The remote site 14 waits for an allocation update or the periodic channel allocation list broadcast to indicate new channel assignments. If the new channel allocation is confirmed, the remote site 14 stops the timer, reconfigures the modulator and turns the modulator on. The remote site 14 confirms the link setup (by using a ping or other similar mechanism) before it resumes user data transfer. If the timer expires, the remote site 14 repeats the sequence. The data transfer continues on the currently allocated channel 22 until the remote modem 30 receives the new channel allocation. If the request fails, the remote modem 30 will continue using the current channel 22.

The primary network control modem 24 upon receiving a channel reallocation request, validates the request. If the request can be granted, the primary network control modem 24 transmits an update indicating the new channel allocation. After a predetermined amount of time, the primary network control modem 24 sends another update indicating the availability of the channel just released by the remote site 14. The primary network control modem 24 also closes the previously opened call record indicating the end time and starts a new call record.

Each remote site 14 that has an active circuit periodically sends a keep-alive message to the primary network control modem 24. If a keep-alive timer expires, the primary network control modem 24 will initiate termination process for that channel.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A network system comprising:
a hub site;
at least one remote site; and
a satellite for transmitting data to and from the hub site and the remote site;
wherein call control and management messages between the hub site and the remote site use internet protocol (IP) addressing for identification.

2. The network system of claim 1 further comprising a plurality of remote sites.

3. The network system of claim 2 further comprising:
a first communication channel to transmit data to the plurality of remote sites; and
a plurality of second communication channels to transmit data from the plurality of remote sites to the hub.

4. The network of claim 1 wherein the hub site comprises:
a primary network control modem for receiving and transmitting data and the call and control management messages to and from the hub site and for maintaining a network database; and
at least one hub receive modem for receiving data from a remote site.

5. The network of claim 4 wherein the hub site further comprises a secondary network control modem to take over functions of the primary network control modem should the primary network control modem fail.

6. The network of claim 1 wherein the at least one remote site comprises a remote modem for continuously receiving data from the hub site and for transmitting data when required.

7. A network system comprising:
a hub site;
a plurality of remote sites; and
a satellite for transmitting data to and from the hub site and the remote site;
wherein available bandwidth of the network is divided into separate channels for transmitting and receiving data; and
wherein call control and management messages between the hub site and the remote site use internet protocol (IP) addressing for identification.

8. A network system in accordance with claim 7 wherein each channel in the network is configured to transmit data only to a defined remote site.

9. A network system in accordance with claim 8 wherein the plurality of channels comprises:
a first communication channel to transmit data to the plurality of remote sites; and
a plurality of second communication channels to transmit data from the plurality of remote sites to the hub.

10. The network of claim 9 wherein the hub site comprises:
a primary network control modem for receiving and transmitting data and the call and control management messages to and from the hub site and for maintaining a network database; and
at least one hub receive modem for receiving data from a remote site.

11. The network of claim 10 wherein the hub site further comprises a secondary network control modem to take over functions of the primary network control modem should the primary network control modem fail.

12. The network of claim 9 wherein each of the plurality of remote sites comprises a remote modem for continuously receiving data from the hub site and for transmitting data when required.

13. The network of claim 10 wherein the primary network control modem maintains a database for storing configuration data and for distributing network data to the plurality of remote sites.

14. The network of claim 10 wherein the data base stored in the primary network control modem maintains a listing of all the plurality of channels in the network; a listing of destination IP addresses and destination HDLC addresses for each of the plurality of channels; a listing of a minimum available bandwidth of each of the plurality of channels and a listing of a guaranteed maximum bandwidth of each of the plurality of channels.

15. The network of claim 14 wherein the data base stored in the primary network control modem maintains a listing of encryption capability of each channel.
